(19) United States
(12) Patent Application Publication
(10) Pub. No.: US 2021/0166253 A1
(43) Pub. Date: Jun. 3, 2021

(54) Table-Based Rate Determination

(71) Applicant: Robert Eammon McGuire, Tokyo (JP)

(72) Inventor: Robert Eammon McGuire, Tokyo (JP)

(21) Appl. No.: 16/951,784

(22) Filed: Nov. 18, 2020

Related U.S. Application Data
(63) Continuation of application No. 15/239,851, filed on Aug. 18, 2016.
Application No. 15/239,851 is a continuation of application No. 13/924,523, filed on Jun. 21, 2013, now abandoned.
Application No. 13/924,523 is a continuation of application No. PCT/JP2011/078888, filed on Dec. 14, 2011.

(30) Foreign Application Priority Data
Dec. 22, 2010 (JP) 2010-286257
Oct. 11, 2011 (JP) 2011-223850

(51) Int. Cl. G06Q 30/02; G06Q 20/20

(52) U.S. Cl. CPC G06Q 30/0206; G06Q 30/0201; G06Q 20/201

(57) ABSTRACT

An input unit (31) inputs a normative first parameter that serves to determine a gross profit rate of a product, and a second parameter relating to a cost of a product. A gross profit rate determination unit (33) references a gross profit rate table to determine a gross profit rate corresponding to an inputted first parameter as the gross profit rate of the pertinent product. A sales price computation unit (34) computes a normative sales price of a product based on an inputted second parameter and a determined gross profit rate of the pertinent product. A sales price database (23) stores standard sales price data showing a normative sales price of a computed product. A display processing unit (35) displays a normative sales price of a product shown by standard sales price data stored in the sales price database.

### CROSS-REFERENCE TO RELATED APPLICATIONS

This application is a continuation of and claims priority to U.S. patent application Ser. No. 15/239,851, filed Aug. 18, 2016, which is hereby incorporated by reference in its entirety.

U.S. patent application Ser. No. 15/239,851 is a continuation of and claims priority to U.S. patent application Ser. No. 13/924,523, filed Jun. 21, 2013, which is hereby incorporated by reference in its entirety.

U.S. patent application Ser. No. 13/924,523 is a continuation of and claims priority to PCT application PCT/JP2011/078888, filed Dec. 14, 2011, which is hereby incorporated by reference in its entirety.

PCT application PCT/JP2011/078888 claims priority to Japanese patent application 2011-223850, filed Oct. 11, 2011 and Japanese patent application 2010-286257, filed Dec. 22, 2010.

### BACKGROUND

Generally, in corporations and the like, products handled by the pertinent corporation are managed using business software such as ERP. Depending on this business software, it may also be possible to calculate, for example, the cost of the products handled by the corporation. The sales price of a product is often determined by referring to the cost of the pertinent product (e.g., the cost of the pertinent product calculated by the business software).

However, even in cases where reference is made to the cost of a product calculated by, for example, the aforementioned type of business software, determination of the sales price of the pertinent product is often greatly affected by market trends. There are also cases where the sales price of a product is determined by commercial negotiations with customers, but the circumstances of such commercial negotiations are often unclear. In short, as product sales prices determined in such ways were not evaluated based on fixed criteria or the like, they may be inappropriate.

### SUMMARY

According to one aspect of the present invention, a sales price management device is provided, including: a gross profit rate table which—for a normative first parameter that serves to determine a gross profit rate of a product—establishes in advance gross profit rates corresponding to pertinent first parameters; an input means which inputs a first parameter of the aforementioned product, and a second parameter relating to a price of the aforementioned product; a determination means which references the aforementioned gross profit rate table to determine a gross profit rate corresponding to the aforementioned inputted first parameter as a gross profit rate of the aforementioned product; a computation means which computes a normative sales price of the aforementioned product based on the aforementioned inputted second parameter and the aforementioned determined gross profit rate of the aforementioned product; a sales price database which stores standard sales price data that shows the aforementioned computed normative sales price of the aforementioned product; and a display means which displays a normative sales price of the aforementioned product shown by standard sales price data stored in the aforementioned sales price database.

According to another aspect of the present invention, a sales price management system is provided which is configured by a terminal employed by a user, and a sales price management device that is communicably connected to the pertinent terminal, wherein the aforementioned sales price management device includes: a gross profit rate table which—for a normative first parameter that serves to determine a gross profit rate of a product—establishes in advance gross profit rates corresponding to pertinent first parameters; an input means which inputs a first parameter of the aforementioned product, and a second parameter relating to a price of the aforementioned product; a determination means which references the aforementioned gross profit rate table to determine a gross profit rate corresponding to the aforementioned inputted first parameter as a gross profit rate of a product; a computation means which computes a normative sales price of the aforementioned product based on the aforementioned inputted second parameter and the aforementioned determined gross profit rate of the aforementioned product; a sales price database which stores standard sales price data that shows the aforementioned computed normative sales price of the aforementioned product; and a transmission means which transmits standard sales price data stored in the aforementioned sales price database to the aforementioned terminal; and wherein the aforementioned terminal includes a display means which displays a standard sales price of a product shown by standard sales price data transmitted by the aforementioned transmission means included in the aforementioned sales price management device.

According to another aspect of the present invention, with respect to a sales price management method which is executed by a sales price management device that has a gross profit rate table that—for a normative first parameter that serves to determine a gross profit rate of a product—establishes in advance gross profit rates corresponding to pertinent first parameters, and a sales price database, a sales price management method is provided, including: a step in which a first parameter of the aforementioned product and a second parameter relating to a price of the aforementioned product are inputted; a step in which the aforementioned gross profit rate table is referenced to determine a gross profit rate corresponding to the aforementioned inputted first parameter as a gross profit rate of the aforementioned product; a step in which a normative sales price of the aforementioned product is computed based on the aforementioned inputted second parameter and the aforementioned determined gross profit rate of the aforementioned product; a step in which standard sales price data that shows the aforementioned computed normative sales price of the aforementioned product is stored in the aforementioned sales price database; and a step in which a normative sales price of the aforementioned product that is shown by standard sales price data stored in the aforementioned sales price database is displayed.

According to another aspect of the present invention, in a sales price management device configured by an external memory that has a gross profit rate table that—for a normative first parameter that serves to determine a gross profit rate of a product—establishes in advance gross profit rates corresponding to pertinent first parameters, and a sales price database, and a computer that utilizes the pertinent external memory, a sales price management program executed by the aforementioned computer causes the following steps to be executed by the aforementioned computer: a step in which a first parameter of the aforementioned product and a second parameter relating to a price of the aforementioned product are inputted; a step in which the aforementioned gross profit rate table is referenced to determine a gross profit rate corresponding to the aforementioned inputted first parameter as a gross profit rate of the aforementioned product; a step in which a normative sales price of the aforementioned product is computed based on the aforementioned inputted second parameter and the aforementioned determined gross profit rate of the aforementioned product; a step in which standard sales price data that shows the aforementioned computed normative sales price of the aforementioned product is stored in the aforementioned sales price database; and a step in which a normative sales price of the aforementioned product that is shown by standard sales price data stored in the aforementioned sales price database is displayed.

### BRIEF DESCRIPTION OF THE DRAWINGS

FIG. 1 is a block diagram which shows a hardware configuration of a sales price management device of a first embodiment of the present invention.

FIG. 2 is a block diagram which shows a main functional configuration of a sales price management device 30 shown in FIG. 1.

FIG. 3 is a drawing which shows one example of a data structure of a gross profit rate table that is stored in a table storage unit 22 shown in FIG. 2.

FIG. 4 is a drawing which serves to explain the relation of sales volume ranking and gross profit rate in the gross profit rate table shown in FIG. 3.

FIG. 5 is a drawing which shows one example of a data structure of an exception table that is stored in the table storage unit 22 shown in FIG. 2.

FIG. 6 is a drawing which shows one example of a data structure of an added-value table that is stored in the table storage unit 22 shown in FIG. 2.

FIG. 7 is a flowchart which shows a processing sequence of standard sales price computation processing executed in the sales price management device 30 of the present embodiment.

FIG. 8 is a drawing which shows one example of a download setting screen.

FIG. 9 is a drawing which shows one example of a data structure of a customer master that is inputted by an input unit 31.

FIG. 10 is a drawing which shows one example of a data structure of a unit price master that is inputted by the input unit 31.

FIG. 11 is a drawing which shows one example of a data structure of a product master that is inputted by the input unit 31.

FIG. 12 is a drawing which shows one example of a data structure of a product cost master that is inputted by the input unit 31.

FIG. 13 is a drawing which shows one example of a data structure of sales performance data that is inputted by the input unit 31.

FIG. 14 is a drawing which shows one example of a data structure of a sales price database 23.

FIG. 15 is a flowchart which shows a processing sequence of gross profit rate determination processing executed by a gross profit rate determination unit 33.

FIG. 16 is a flowchart which shows a processing sequence of standard sales price display processing executed by the sales price management device 30 of the present embodiment.

FIG. 17 is a drawing which shows one example of a main menu screen.

FIG. 18 is a drawing which shows one example of a standard sales price confirmation screen.

FIG. 19 is a block diagram which shows a main functional configuration of a sales price management device 50 of a second embodiment of the present invention.

FIG. 20 is a drawing which shows one example of a data structure of a planned sales volume table that is stored in a table storage unit 24 shown in FIG. 19.

FIG. 21 is a flowchart which shows a processing sequence of estimate preparation processing executed in the sales price management device 50 of the present embodiment.

FIG. 22 is a drawing which shows one example of an estimate menu screen.

FIG. 23 is a flowchart which shows a processing sequence of gross profit rate determination processing executed by a gross profit rate determination unit 52.

FIG. 24 is a block diagram which shows a main functional configuration of a sales price management device 100 of a third configuration of the present invention.

FIG. 25 shows one example of a data structure of a unit price master that is stored in a sales price database 25 after registration of sales price data.

FIG. 26 is a flowchart which shows a processing sequence of the sales price management device 100 of the present embodiment.

### DETAILED DESCRIPTION

The respective embodiments of the present invention are described below with reference to drawings.

### Embodiment 1

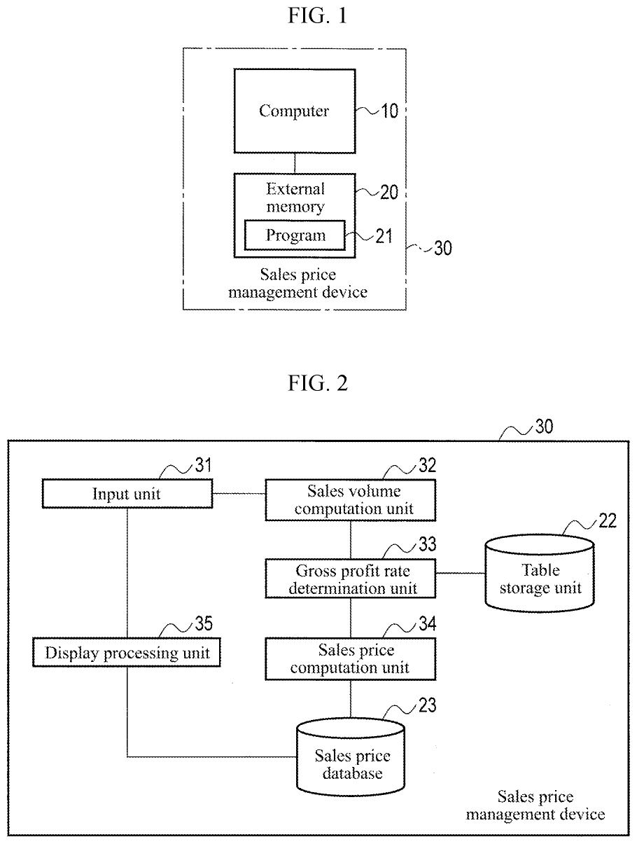

First, a first embodiment of the present invention is described with reference to FIG. 1 and FIG. 2. FIG. 1 is a block diagram which shows a hardware configuration of a sales price management device of the present embodiment. As shown in FIG. 1, a computer 10 is connected to an external memory 20 such as a hard disk drive (HDD). This external memory 20 stores a program 21 that is executed by the computer 10. The computer 10 and the external memory 20 configure a sales price management device 30.

This sales price management device 30 has a function which computes a normative sales price of the pertinent product based on, for example, product cost. The sales price management device 30 may be used, for example, in corporations or the like which sell the product to customers.

FIG. 2 is a block diagram which shows the main functional configuration of the sales price management device 30 shown in FIG. 1. As shown in FIG. 2, the sales price management device 30 includes an input unit 31, a sales volume computation unit 32, a gross profit rate determination unit 33, a sales price computation unit 34, and a display processing unit 35. In the present embodiment, these respective units 31-35 are actualized by having the computer 10 shown in FIG. 1 execute a program (sales price management program) 21 that is stored in the external memory 20. This program 21 may be stored and distributed in advance in a readable memory medium of the computer. It is also acceptable, for example, to download this program 21 into the computer 10 via a network.

The sales price management device 30 also includes a table storage unit 22 and a sales price database 23. In the present embodiment, the table storage unit 22 and sales price database 23 are, for example, stored in the external memory 20.

A gross profit rate table, an exception table, and an added-value table are stored in the table storage unit 22.

For a normative parameter (first parameter) that serves to determine a gross profit rate of a product—e.g., a sales volume (rank)—the gross profit rate table establishes in advance gross profit rates corresponding to pertinent sales volumes.

Specifically, for each rank, the gross profit rate table associatively establishes (data showing) a sales volume range corresponding to the pertinent rank, and a gross profit rate corresponding to the pertinent rank (the pertinent sales volume range).

The exception table defines in advance special provisions relating to predetermined conditions and gross profit rates corresponding to the pertinent conditions.

The added-value table establishes in advance gross profit rates that are added according to added-value ranks of the product (hereinafter denoted as “additional gross profit rate”). Specifically, the added-value table establishes correspondence of additional gross profit rates with respective added-value ranks of the product.

The input unit 31 inputs information required for purposes of computing the sales price of the product. The input unit 31 inputs, for example, customer master (data), unit price master (data), product master (data), product cost master (data), and sales performance data (second parameter). The customer master contains data relating to customers who are the recipients of product sales. The unit price master contains data relating to current sales prices (unit prices) of the product. The product master contains data relating to the product. The product cost master contains data relating to costs of the product (cost data showing costs of the pertinent product). Sales performance data is a parameter related to determination of a price of a product in the present embodiment, and shows, for example, sales volumes of the product per customer.

The customer master, unit price master, product master, product cost master, and sales performance data may, for example, be inputted from business software (ERP) introduced into the corporation or the like.

The input unit 31 inputs added-value ranks of the product according to user operations. These added-value ranks of the product are designated by the user using the sales price management device 30.

The sales volume computation unit 32 computes sales volumes of the pertinent product based on sales performance data inputted by the input unit 31 (totals the sales volumes of the pertinent product shown by the sales performance data).

The gross profit rate determination unit 33 references the gross profit rate table stored in the table storage unit 22 to determine a gross profit rate corresponding to a sales volume of the product computed by the sales volume computation unit 32 as the gross profit rate of the pertinent product.

At this time, in the case where the product falls under conditions defined in the exception table stored in the table storage unit 22, the gross profit rate determination unit 33 determines the gross profit rate of the pertinent product with application of the special provisions defined in the exception table according to the pertinent conditions.

The gross profit rate determination unit 33 also adds an additional gross profit rate to be added according to the added-value rank of the product inputted by the input unit 31 to the aforementioned gross profit rate corresponding to the sales volume of the product. The additional gross profit rate to be added according to the added-value rank of the product is specified by referring to the aforementioned added-value table.

The sales price computation unit 34 computes a normative sales price of the pertinent product (hereinafter denoted as “standard sales price”) based on a cost of the product shown by cost data contained in the product cost master inputted by the input unit 31 and a gross profit rate of the pertinent product determined by the gross profit rate determination unit 33.

The sales price database 23 stores data which shows standard sales prices of the product computed by the sales price computation unit 34 (hereinafter denoted as “standard sales price data”). Data and the like contained in the customer master, unit price master, product master, and product cost master inputted by the input unit 31 are stored as necessary in the sales price database 23.

The display processing unit 35 displays standard sales prices of the product designated by the user based on the various types of data stored in the sales price database 23.

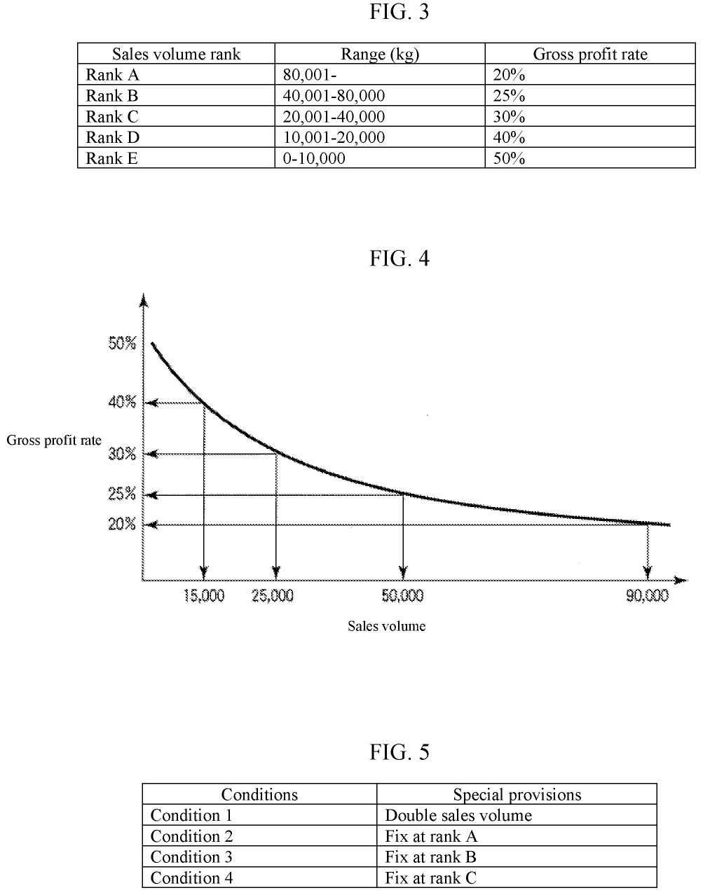

Next, referring to FIG. 3, a detailed description is given of a gross profit rate table stored in the table storage unit 22 shown in FIG. 2. FIG. 3 shows one example of a data structure of a gross profit rate table stored in the table storage unit 22.

As shown in FIG. 3, the gross profit rate table establishes correspondence among sales volume ranks, ranges, and gross profit rates. Sales volume ranks are expressed in a format that ranks sales volumes of the product, and include, for example, ranks A to E. Ranges indicate ranges (kg) of sales volumes of the product equivalent to corresponding sales volume ranks. Gross profit rates indicate gross profit rates according to (ranges of sales volumes equivalent to) corresponding sales volume ranks.

In the example shown in FIG. 3, the gross profit rate table establishes a correspondence among a sales volume rank of “rank A,” a range of “80,001-,” and a gross profit rate of “20%.”

According to this, it is indicated that the range equivalent to the sales volume rank of “rank A” is 80,001 (kg) or more, and that the gross profit rate corresponding to the pertinent sales volume rank “rank A” is 20%.

In addition, the gross profit rate table establishes a correspondence among a sales volume rank of “rank B,” a range of “40,001-80,000,” and a gross profit rate of “25%.” According to this, it is indicated that the range equivalent to the sales volume rank of “rank B” is 40,001 (kg) to 80,000 (kg), and that the gross profit rate corresponding to the pertinent sales volume rank of “rank B” is 25%.

Furthermore, the gross profit rate table establishes a correspondence among a sales volume rank of “rank C,” a range of “20,001-40,000,” and a gross profit rate of “30%.” According to this, it is indicated that the range equivalent to the sales volume rank of “rank C” is 20,001 (kg) to 40,000 (kg), and that the gross profit rate corresponding to the pertinent sales volume rank of “rank C” is 30%.

In addition, the gross profit rate table establishes a correspondence among a sales volume rank of “rank D,” a range of “10,001-20,000,” and a gross profit rate of “40%.” According to this, it is indicated that the range equivalent to the sales volume rank of “rank D” is 10,001 (kg) to 20,000 (kg), and that the gross profit rate corresponding to the pertinent sales volume rank of “rank D” is 40%.

Similarly, the gross profit rate table establishes a correspondence among a sales volume rank of “rank E,” a range of “0-10,000,” and a gross profit rate of “50%.” According to this, it is indicated that the range equivalent to the sales volume rank of “rank E” is 0 (kg) to 10,000 (kg), and that the gross profit rate corresponding to the pertinent sales volume rank of “rank E” is 50%.

Now, the relation between gross profit rates and sales volume ranks (sales volumes of the product) in the gross profit rate table shown in FIG. 3 are described with reference to FIG. 4.

In the case where the sales volume is, for example, 15,000 (kg) in the gross profit rate table shown in FIG. 3 as described above, the pertinent sales volume falls under the sales volume rank of “rank D,” and the gross profit rate corresponding to the pertinent sales volume rank is 40%. In the case where the sales volume is, for example, 25,000 (kg), the pertinent sales volume falls under the sales volume rank of rank “C,” and the gross profit rate corresponding to the pertinent sales volume rank is 30%. Furthermore, in the case where the sales volume is, for example, 50,000 (kg), the pertinent sales volume falls under the sales volume rank of rank “B,” and the gross profit rate corresponding to the pertinent sales volume rank is 25%. Moreover, in the case where the sales volume is, for example, 90,000 (kg), the pertinent sales volume falls under the sales volume rank of rank “A,” and the gross profit rate corresponding to the pertinent sales volume rank is 20%.

In short, as shown in FIG. 4, the gross profit rates corresponding to sales volumes established in the gross profit rate table decrease as the sales volumes rise, and increase as the sales volumes decline. In other words, in the gross profit rate table, lower gross profit rates are correspondingly established with respect to sales volumes of higher rank, and higher gross profit rates are correspondingly established with respect to sales volumes of lower rank.

This is based on the concept that cost tends to increase as the sales volume of a product declines, and furthermore that even when the gross profit rate is raised, it has little effect.

The relation between gross profit rates and sales volume ranks (sales volumes of the product) as shown in FIG. 4 is one example, and the pertinent gross profit rates may be determined according to the industrial category or the like for which the product is handled.

Next, referring to FIG. 5, a detailed description is given of an exception table stored in the table storage unit 22 shown in FIG. 2. FIG. 5 shows one example of a data structure of an exception table stored in the table storage unit 22.

As shown in FIG. 5, the exception table establishes correspondences between conditions and special provisions. The conditions are conditions for the purpose of applying corresponding special provisions, and are defined in advance. The (contents of the) special provisions are applied when the product meets the corresponding conditions.

In the example shown in FIG. 5, the condition of “condition 1” and the exceptional provision of “double the sales volume” are defined in the exception table. This condition 1 includes, for example, whether the product is a seasonal product (summer item, winter item, etc.) and the like. According to this, it is indicated that the sales volume of the product is doubled in the case where the pertinent product meets condition 1.

In addition, the condition of “condition 2” and the exceptional provision of “fix at rank A” are defined in the exception table. This condition 2 includes, for example, whether the product is a new product and the like. According to this, it is indicated that the sales volume rank of the product (the sales volume rank established in the gross profit rate table shown in FIG. 3) is to be fixed at rank A in the case where the pertinent product meets condition 2.

Furthermore, the condition of “condition 3” and the exceptional provision of “fix at rank B” are defined in the exception table. This condition 3 includes, for example, whether the product is a by-product and the like. According to this, it is indicated that the sales volume rank of the product is to be fixed at rank B in the case where the pertinent product meets condition 3.

Moreover, the condition of “condition 4” and the exceptional provision of “fix at rank C” are defined in the exception table. This condition 4 includes, for example, whether the product is an accessory product and the like. According to this, it is indicated that the sales volume rank of the product is to be fixed at rank C in the case where the pertinent product meets condition 4.

It is also acceptable for the exception table to define conditions and special provisions other than those described above.

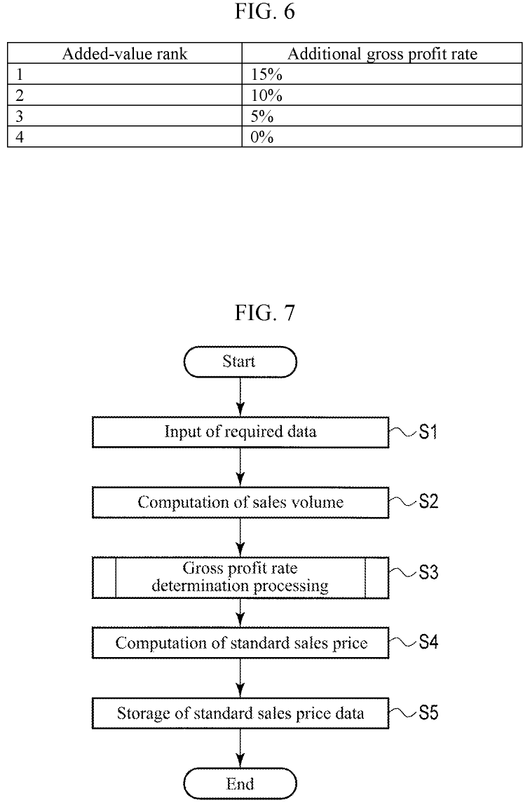

Next, referring to FIG. 6, a detailed description is given of the added-value table stored in the table storage unit 22 shown in FIG. 2. FIG. 6 shows one example of a data structure of an added-value table stored in the table storage unit 22.

As shown in FIG. 6, the added-value table establishes correspondences between additional gross profit rates and added-value ranks of the product (hereinafter denoted as “added-value ranks”). The added-value ranks include, for example, (the values of) 1 to 4, expressing that the added value of the product increases as these values decline. For example, in the case of products for which substitutes do not exist at competitors or the like, it is considered that the added-value of the pertinent product is high. The additional gross profit rate indicates a gross profit rate that is added according to a corresponding added-value rank.

In the example shown in FIG. 6, the added-value table establishes a correspondence between an added-value rank of “1” and an additional gross profit rate of “15%.” According to this, it is indicated that the gross profit rate to be added at an added-value rank of “ 1” is 15%.

In addition, the added-value table establishes a correspondence between an added-value rank of “2” and an additional gross profit rate of “10%.” According to this, it is indicated that the gross profit rate to be added at an added-value rank of “2” is 10%.

Furthermore, the added-value table establishes a correspondence between an added-value rank of “3” and an additional gross profit rate of “5%.” According to this, it is indicated that the gross profit rate to be added at an added-value rank of “3” is 5%.

Moreover, the added-value table establishes a correspondence between an added-value rank of “4” and an additional gross profit rate of “0%.” According to this, it is indicated that the gross profit rate to be added at an added-value rank of “4” is 0% (in short, nothing is to be added).

According to this type of added-value table, the gross profit rate to be added (i.e., the additional gross profit rate) increases with products of higher added value.

Next, the operations of the sales price management device 30 of the present embodiment are described. In the sales price management device 30 of the present embodiment, processing which computes a normative sales price of the product (standard sales price) (hereinafter denoted as “standard sales price computation processing”) and processing which displays a standard sales price of the pertinent product to a user (for example, a salesperson) (hereinafter denoted as “standard sales price display processing”) are performed. This processing is described below.

First, with reference to the flowchart of FIG. 7, the processing sequence of the standard sales price computation processing performed in the sales price management device 30 of the present embodiment is described. This sales price computation processing is performed, for example, at predetermined intervals (e.g., once a day). For purposes of convenience, computation of the standard sales price of a single product is described here.

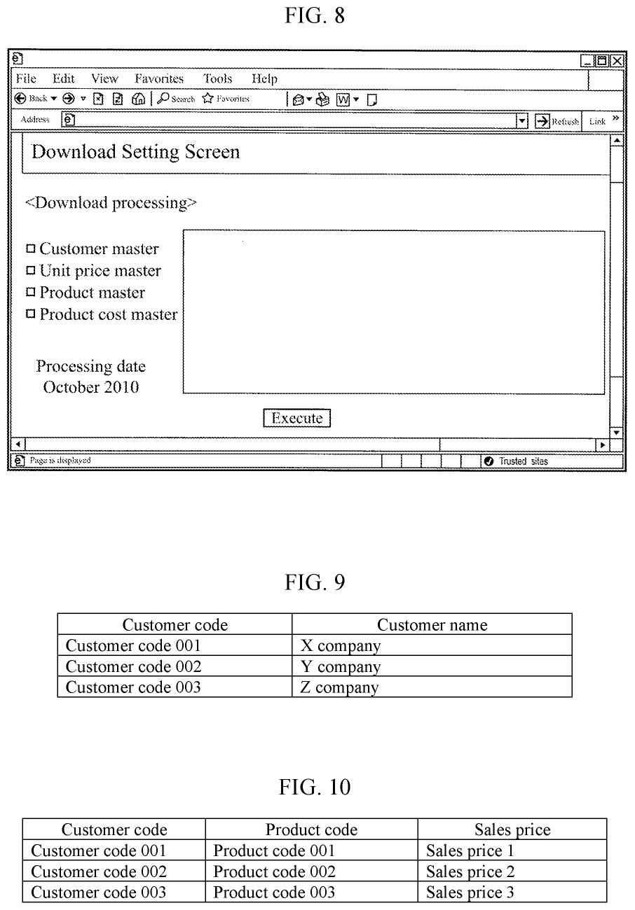

The input unit 31 inputs the data required in sales price computation processing (step S1). Here, the input unit 31 inputs a customer master, unit price master, product master, product cost master, and sales performance data (sales volume data). This data may be downloaded from, for example, business software or the like as mentioned above. The data to be downloaded from the business software (information required in sales price computation processing) may be designated in advance in a download setting screen, as shown, for example, in FIG. 8.

Here, with reference to FIG. 9 to FIG. 13, the various types of data inputted by the input unit 31 are described in detail.

FIG. 9 shows one example of a data structure of a customer master that is inputted by the input unit 31. As shown in FIG. 9, the customer master contains correspondences between customer codes and customer names. Customer codes are identifiers that serve to identify customers who are sale recipients of the product. Customer names are the appellations of customers which are identified by corresponding customer codes.

In the example shown in FIG. 9, the customer master includes a correspondence between a customer code of “customer code 001” and “X Company.” According to this, it is indicated that the customer name (appellation) of the customer identified by the customer code of “customer code 001” is X Company.

In addition, the customer master includes a correspondence between a customer code of “customer code 002” and a customer name of “Y Company.” According to this, it is indicated that the customer name of the customer identified by the customer code of “customer code 002” is Y Company.

Furthermore, the customer master includes a correspondence between a customer code of “customer code 003” and a customer name of “Z Company.” According to this, it is indicated that the customer name of the customer identified by the customer code of “customer code 003” is Z Company.

FIG. 10 shows one example of a data structure of a unit price master inputted by the input unit 31. As shown in FIG. 10, the unit price master contains correspondences between customer codes, product codes, and sales prices (unit prices). As with the customer codes included in the above-described customer master, customer codes are identifiers that serve to identify customer names. Product codes are identifiers that serve to identify products. Sales prices indicate unit prices of products that are identified by product codes for customers identified by corresponding customer codes (e.g., sales price per 1 kg).

In the example shown in FIG. 10, the unit price master includes a correspondence among a customer code of “customer code 001,” a product code of “product code 001,” and a sales price of “sales price 1.” According to this, it is indicated that the sales price of a product identified by the product code of “product code 001” relative to a customer identified by the customer code of “customer code 001” (unit price when the pertinent product is sold to the pertinent customer) is sales price 1.

In addition, the unit price master includes a correspondence among a customer code of “customer code 002,” a product code of “product code 001,” and a unit price of “unit price 2.” According to this, it is indicated that the sales price of a product identified by the product code of “product code 001” relative to a customer identified by the customer code of “customer code 002” is sales price 2.

Furthermore, the unit price master includes a correspondence among a customer code of “customer code 003,” a product code of “product code 001,” and a unit price of “unit price 3.” According to this, it is indicated that the sales price of a product identified by the product code of “product code 001” relative to a customer identified by the customer code of “customer code 003” is sales price 3.

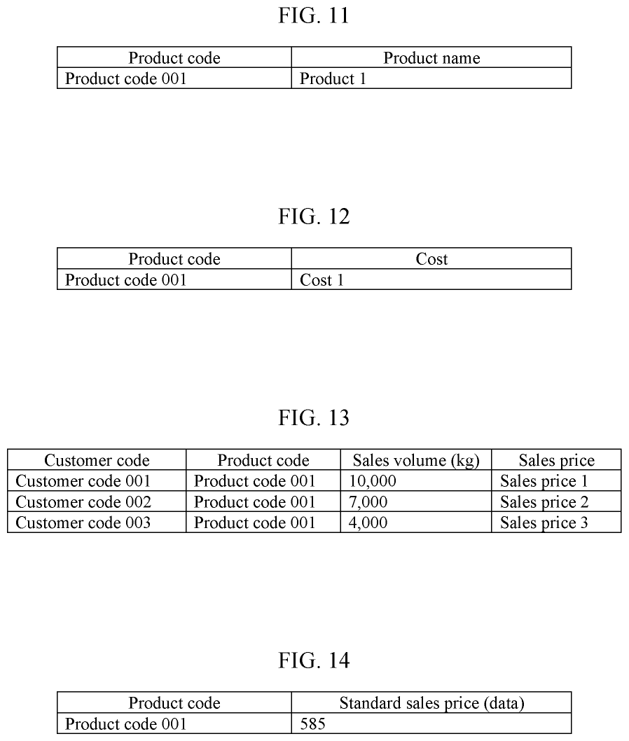

FIG. 11 shows one example of a data structure of a product master inputted by the input unit 31. As shown in FIG. 11, the product master contains correspondences between product codes and product names. The product codes are identical to the product codes contained in the unit price master described above, and are identifiers that serve to identify products. The product names are appellations of the product which are identified by corresponding product codes.

In the example shown in FIG. 11, the product master includes a correspondence between a product code of “product code 001” and a product name of “product 1.” According to this, it is indicated that the product name identified by the product code of “product code 001” is product

In the description given here, the product master contains only product codes and product names, but it is also acceptable to store correspondences with product codes (and product names) for purposes of identifying a pertinent product by product-related data (hereinafter denoted as “product data”) that serves, for example, to determine whether or not the various types of conditions defined in the aforementioned exception table apply. This product information would indicate, for example, that the pertinent product is a seasonal product, new product, by-product or accessory product or the like.

FIG. 12 shows one example of a data structure of a product cost master inputted by the input unit 31. As shown in FIG. 12, the product cost master contains correspondences between product codes and costs. The product codes are identical to the product codes contained in the unit price master and the like described above, and are identifiers that serve to identify products. The costs are costs of products identified by corresponding product codes. The costs contained in this product cost master are, for example, costs based on calculations (cost calculations) of the aforementioned business software of the like, particularly recent purchase prices or projected purchase prices or the like.

In the example shown in FIG. 12, the product cost master includes a correspondence between the product code of “product code 001” and the cost of “cost 1.” According to this, it is indicated that the cost of the product identified by the product code of “product code 001” is cost 1.

FIG. 13 shows one example of a data structure of sales performance data inputted by the input unit 31. As shown in FIG. 13, the sales performance data contains correspondences among customer codes, product codes, sales volumes (kg), and sales prices (unit prices).

The customer codes are identical to the customer codes contained in the customer master and the like described above, and are identifiers that serve to identify customers. The product codes are identical to the product codes contained in the unit price master and the like described above, and identifiers that serve to identify products. These sales volumes indicate quantities of products identified by product codes that are sold to customers identified by corresponding customer codes. The sales prices indicate sales prices of products at the point when the pertinent product that is identified by a product code is sold to customers identified by corresponding customer codes.

Although not illustrated in FIG. 13, sales performance data may also contain data such as the date, time and the like when a product identified by a product code was sold to a customer identified by a customer code.

In the example shown in FIG. 13, the sales performance data includes a correspondence among the customer code of “customer code 001,” the product code of “product code 001,” the sales volume of “10,000,” and the sales price of “sales price 1.” According to this, it is indicated that a product identified by the product code of “product code 001” was sold in the amount of 10,000 kg at sales price 1 to a customer identified by the customer code of “customer code 001.”

In addition, the sales performance data includes a correspondence among the customer code of “customer code 002,” the product code of “product code 001,” the sales volume of “7,000,” and the sales price of “sales price 2.” According to this, it is indicated that a product identified by the product code of “product code 001” was sold in the amount of 7,000 kg at sales price 2 to a customer identified by the customer code of “customer code 002.”

Furthermore, the sales performance data includes a correspondence among the customer code of “customer code 003,” the product code of “product code 001,” the sales volume of “4,000,” and the sales price of “sales price 3.” According to this, it is indicated that a product identified by the product code of “product code 001” was sold in the amount of 4,000 kg at sales price 3 to a customer identified by the customer code of “customer code 003.”

With respect to the aforementioned FIG. 10 to FIG. 13, the description mainly concerned data relating to a single product (a product identified by the product code of “product code 001”), but data relating to other products would also be similarly inputted.

Apart from the above-described customer master, unit price master, product master, product cost master, and sales performance data, the input unit 31 inputs added-value ranks of products. These added-value ranks are, for example, designated by the user.

Returning again to FIG. 7, the sales volume computation unit 32 computes a sales volume of a product within a prescribed period (for example, the total sales volume of the pertinent product relative to all customers over the past one year period) based on sales performance data inputted by the input unit 31 (step S2).

Here, the sales performance data inputted by the input unit 31 as described in the aforementioned FIG. 13 contains correspondences among customer codes, product codes, sales volumes, and sales prices. Consequently, when computing a sales volume of a product, the sales volume computation unit 32 computes the totals of the sales volumes included in the sales performance data corresponding to product codes that serve to identify the pertinent products.

Next, the gross profit rate determination unit 33 performs processing that determines the gross profit rate (%) of a product (hereinafter denoted as gross profit rate determination processing) based on the sales volume of the pertinent product computed by the sales volume computation unit 32 (step S3). At this time, the gross profit rate determination unit 33 references the gross profit rate table, exception table, and added-value table stored in the table storage unit 22 to perform the gross profit rate determination processing. The particulars of gross profit rate determination processing are described below.

The sales price computation unit 34 computes the standard sales price of a product based on the cost of the product contained in the product cost master inputted by the input unit 31 and the gross profit rate of the product determined by the gross profit rate determination unit 33 (step S4).

The standard sales price of a product corresponds to X in the calculation formula of “(X−cost of product) I X=gross profit rate of product.” Accordingly, the sales price computation unit 34 computes the standard sales price of the pertinent product by obtaining X by substituting the cost of the product and the gross profit rate of the product in this formula. When the standard sales price computation processing of a product is specifically described with 380 (yen) as the cost of the product and 35% (i.e., 0.35) as the gross profit rate of the product, it results in computation of X=585 by “(X−380)/X=0.35.” In short, in the case where the cost of the product is 380 (yen) and the gross profit rate of the product is 35% (i.e., 0.35), “585 (yen)” is computed as the standard sales price of the product in this manner.

This standard sales price of the product computed by the sales price computation unit 34 is, for example, a sales price per 1 kg of the pertinent product (i.e., a unit price).

The sales price computation unit 34 stores standard sales price data showing the computed standard sales price of the product in the sales price database 23 (step S5). The standard sales price data showing the standard sales price of the product is stored in the sales price database 23 corresponding to a product code that serves to identify the pertinent product, as shown in FIG. 14. In FIG. 14, only the product codes and the standards sales price data are stored, but one may also store, for example, the various types of data inputted in step S1 in the sales price database 23.

When the aforementioned processing of step S5 is performed, sales price computation processing terminates. Here, for purposes of convenience, a description was given of computation of a standard sales price for a single product, but in the case where multiple products exist, standard sales prices of the respective products are computed by repeating the processing of steps S2-S5 shown in FIG. 7 for each of the pertinent products.

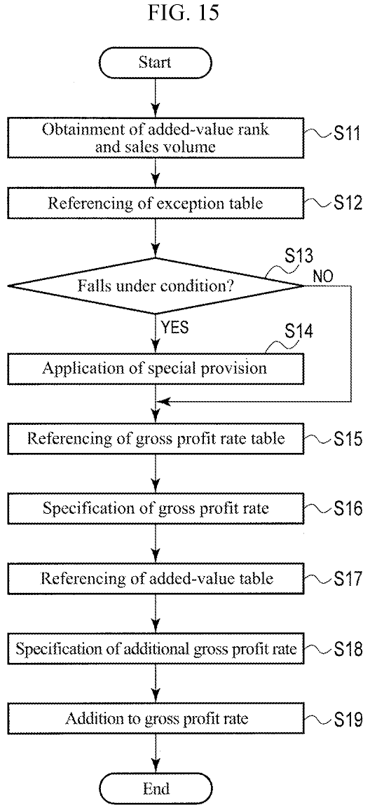

Here, a description is given of the processing sequence of gross profit rate determination processing performed by the aforementioned gross profit rate determination unit 33, with reference to the flowchart of FIG. 15.

First, the gross profit rate determination unit 33 obtains the added-value rank of the product inputted by the input unit 31 and the sales volume (sold amount) of the product computed by the sales volume computation unit 32 (step S11). The gross profit rate determination unit 33 also obtains product data (data relating to the product) contained in the product master inputted by the input unit 31.

Next, the gross profit rate determination unit 33 references the exception table stored in the table storage unit 22 (step S12).

The gross profit rate determination unit 33 determines whether or not the product falls under the conditions retained in the exception table based on the obtained product data (step S13).

In the case where it is determined that the product falls under the conditions (YES of step S13), the special provisions defined in the exception table that correspond to the conditions under which the pertinent product falls are applied (step S14).

Here, when a detailed description is given using the aforementioned FIG. 5, in the case where the product falls under condition 1 (e.g., it is a seasonal product), the gross profit rate determination unit 33 doubles the sales volume obtained in step S11 by applying the special provision defined in the exception table corresponding to the pertinent condition 1. In the case where the product falls under condition 2 (e.g., it is a new product), the gross profit rate determination unit 33 fixes the sales volume rank of the pertinent product at rank A by applying the special provision defined in the exception table corresponding to the pertinent condition 2. In the case where the product falls under condition 3 (e.g., it is a by-product), the gross profit rate determination unit 33 fixes the sales volume rank of the pertinent product at rank B by applying the special provision defined in the exception table corresponding to the pertinent condition 3. In the case where the product falls under condition 4 (e.g., it is an accessory product), the gross profit rate determination unit 33 fixes the sales volume rank of the pertinent product at rank C by applying the special provision defined in the exception table corresponding to the pertinent condition 3 [sic].

On the other hand, in the case where it is determined that the product is not fall under any of the conditions (NO of step S13), the processing of step S14 is not performed.

Next, the gross profit rate determination unit 33 references the gross profit rate table stored in the table storage unit 22 (step S15).

The gross profit rate determination unit 33 specifies a gross profit rate corresponding to a sales volume of the product obtained in step S11 or a processing result of the aforementioned step S14 (step S16).

Specifically, in the case where the aforementioned processing of step S14 is not performed, the gross profit rate determination unit 33 specifies the gross profit rate retained in the gross profit rate table that corresponds to the sales volume rank that corresponds to the range in which the obtained sales volume of the product falls. In the case where the sales volume obtained in step S11 is, for example, 25,000 (kg) according to the gross profit rate table shown in the aforementioned FIG. 3, 30% is specified as the gross profit rate.

On the other hand, in the case where, for example, the sales volume of the product is doubled in the aforementioned step S14, the gross profit rate determination unit 33 specifies the gross profit rate retained in the gross profit rate table that corresponds to the sales volume rank that corresponds to the range in which the pertinent doubled sales volume of the product falls. In the case where the sales volume of the product is fixed at, for example, rank A in step S14, the gross profit rate determination unit 33 specifies the gross profit rate retained in the gross profit rate table corresponding to the pertinent rank A (20% according to the gross profit rate table shown in FIG. 3). Similarly, in the case where the sales volume of the product is fixed at rank B or C in step S14, the gross profit rate determination unit 33 specifies the gross profit rate retained in the gross profit rate table corresponding to the pertinent rank.

Next, the gross profit rate determination unit 33 references the added-value table stored in the table storage unit 22 (step S17).

The gross profit rate determination unit 33 specifies an additional gross profit rate corresponding to the added-value rank obtained in step S11 (step S18). Specifically, the gross profit rate determination unit 33 specifies an additional gross profit rate retained in the added-value table corresponding to the added-value rank obtained in step S11.

The gross profit rate determination unit 33 adds the additional gross profit rate specified in step S18 to the gross profit rate specified in step S16 (step S19).

When the processing of step S19 is performed, the gross profit rate after addition of the additional gross profit rate in the pertinent step S19 is transmitted to the sales price computation unit 34 as the processing result of gross profit rate determination processing (i.e., the gross profit rate of the product).

The description given here concerned determination of the gross profit rate of a product using all of the tables—gross profit rate table, exception table, and added-value table—stored in the table storage unit 22, but it is also acceptable to have a configuration where the gross profit rate of a product is determined, for example, using only a gross profit rate table, or a configuration where the gross profit rate of a product is determined using either a gross profit rate table or an exception table and an added-value table.

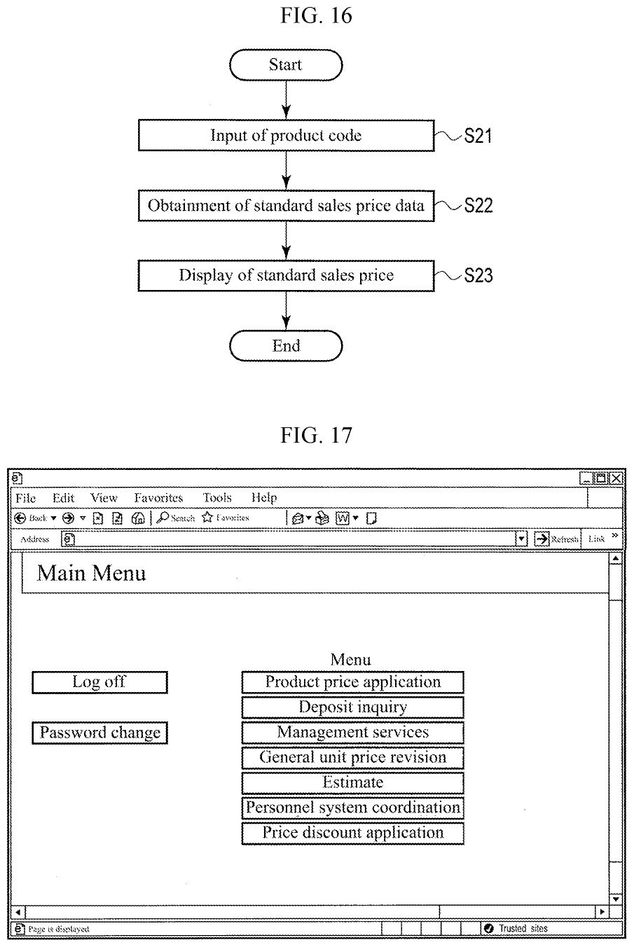

Next, a description is given of the processing sequence of standard sales price display processing performed in the sales price management device 30 of the present embodiment, with reference to the flowchart of FIG. 16. Here, the description is given with respect to storage in a sales price database 23 of standard sales price data showing the standard sales prices of products corresponding to respective product codes and identified by the pertinent product codes. The sales price database 23 stores data such as the aforementioned customer master, unit price master, product master, and product cost master.

Standard sales price display processing is performed by pressing (designating), for example, a “product price application” button on a main menu screen provided with various types of buttons as shown in FIG. 17.

First, the input unit 31 inputs a product code designated by a user according to the manipulation of the pertinent user (step S21). Here, the product code inputted by the input unit 31 is a product code that serves to identify the product for which the user wishes to display (check) the standard sales price.

Next, the display processing unit 35 obtains the standard sales price data stored in the sales price database 23 corresponding to the product code inputted by the input unit 31.

The display processing unit 35 displays the standard sales price of the product shown by the obtained standard sales price data (i.e., the standard sales price of the product designated by the user) (step S23).

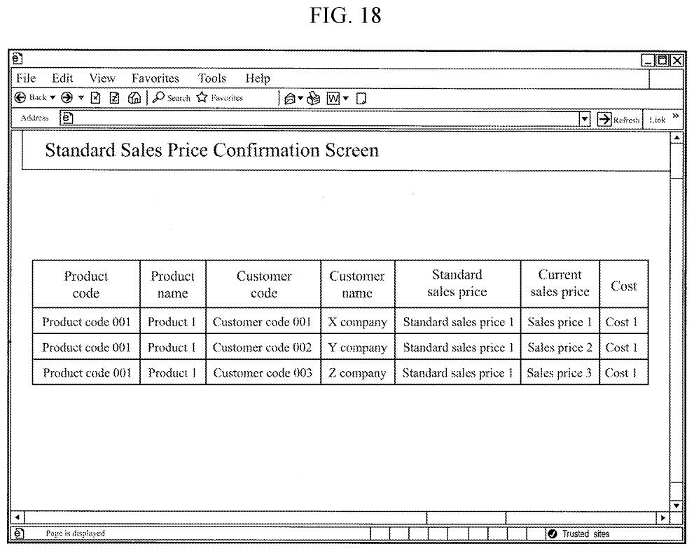

When the standard sales price of the product designated by the user is displayed, it is preferable that the various types of data relating to the pertinent product stored in the sales price database 23 also be similarly display, as, for example, on the screen shown in FIG. 18. In the case shown in FIG. 18, for example, the product code identifying the product designated by the user, the product name of the pertinent product, the customer code serving to identify the customer who is the sales recipient of the pertinent product, the customer name of the pertinent customer, the standard sales price of the pertinent product, the current sales price of the pertinent product with respect to the pertinent customer, and the cost of the pertinent product are displayed. FIG. 18 shows one example of a standard sales price confirmation screen that conducts display in the case where the product code of “product code 001” is designated by the user.

By having a user check such a standard sales price confirmation screen, the pertinent user can grasp the standard sales price of the product, and can also easily compare the pertinent standard sales price with current sales prices or the like by customer.

In the present embodiment as described above, by means of a configuration wherein a gross profit rate table is referenced to determine a gross profit rate of a product corresponding to a sales volume of the product indicated by sales volume data, a standard sales price of the pertinent product is computed based on the cost of the pertinent product and the gross profit rate of the pertinent product, and the standard sales price of the pertinent product is displayed, it is possible, for example, to compute appropriate sales prices (standard sales prices) based on costs that fluctuate monthly and objective figures of market trends (i.e., sales volumes) that fluctuate monthly, and adopt the pertinent standard sales prices as guides for sales or management strategy.

In the present embodiment, it is possible to compute standard sales prices based on appropriate gross profit rates of the product by means of a configuration wherein gross profit rates decline as sales volumes increase, and gross profit rates rise as sales volumes decrease in the gross profit rate table.

For example, it is often the case that a customer who purchases a product with low sales volume has not secured other corporations or the like from whom the pertinent product can be purchased. Furthermore, many competitors do not wish to waste development time and the like on products of low sales volume. That is, products of low sales volume are inflexible relative to sales price increases. With respect to such products, it is often the case that transactions continue even when the sales price is increased.

On the other hand, when considering customers who purchase products in large quantity, increases in the sales price (unit price) of the pertinent product have a large impact compared to products that are purchased in small quantity. Accordingly, when such products of high sales volume are subjected to a sales price (unit price) increase, the customer may shift its business to a competitor. As competitors wish to secure customer relationships for products which can be sold in large quantity, price increases and the like must be carefully conducted with respect to the aforementioned products of high sales volume.

Product salespeople often think that it is important to set a high gross profit rate for products of high sales volume, but such thinking is very risky due to the possibility that customers may be taken away by competitors, given that competitors are also thinking in terms of conducting business in the pertinent products as described above. Furthermore, competition is fierce with respect to products of high sales volume, and it may be necessary to lower the gross profit rate (i.e., reduce the sales price) in cases where, for example, a customer makes a price reduction request, or a competitor has developed a new product.

Thus, with respect to the sales price management device 30 of the present embodiment, treatment of products of high sales volume and products of low sales volume can be distinguished in the gross profit rate table. By this means, for example, a salesperson can conduct negotiations to lower the gross profit rate of a product of high sales volume on the condition that the gross profit rate of a product of low sales volume is increased.

In other words, according to the sales price management device 30 of the present embodiment, taking into account the aforementioned circumstances, it is possible to respond to competition in products of high sales volume, while maximizing profits in the category of products of low sales volume.

Therefore, by utilizing the sales price management device 30 of the present embodiment, corporations can carry out appropriate and stable pricing strategies.

In the present embodiment, by means of a configuration wherein current sales prices of a product can also be displayed in addition to the standard sales price of the pertinent product, the user can easily compare and analyze the pertinent standard sales price and current sales prices, enabling sound management of corporate earnings and finances based on these results.

In the present embodiment, by means of a configuration wherein an exception table is referenced to determine a gross profit rate of a product, it is possible to determine appropriate gross profit rates, and compute standard sales prices, even in cases where, for example, the pertinent product is a seasonal product, new product, by-product or accessory product, and gross profit rates cannot be determined merely with simple sales volumes.

In the present embodiment, by means of a configuration wherein an added-value table is referenced to determine gross profit rates of the product, gross profit rates can be determined, and standard sales prices can be computed taking into account added value of the pertinent product.

According to the sales price management device 30 of the present embodiment, raising the sales price of a high-volume product can be easily conducted by computing and managing normative product sales prices using the gross profit rate table. In businesses affected by cost fluctuations, plans for appropriate increases in product sales prices can be managed in an organized and effective manner on a corporate level. That is, according to the sales price management device 30 of the present embodiment, plans for sales price increases can be reflected in actual product sales, and the effectiveness of increases in the pertinent sales prices can be managed by managing standard sales prices and actual product sales prices.

Furthermore, in the present embodiment, it is possible to manage product life cycles and sales prices of the pertinent products. In some cases, sales volumes of products decline as they are sold over long periods. Despite this, ordinarily, marketing continues at the original sales price without increasing the value-added costs for transport of the pertinent products of low sales volume. According to the sales price management device 30 of the present embodiment, sales prices can be constantly adjusted according to changes in the sales volumes of such products, because it is possible to compute a minimum sales price (i.e., a standard sales price) of a product according to a lifecycle (sales volumes) of the pertinent product.

In the present embodiment, by computing and managing standard sales prices of products in this manner, in cases where, for example, a sales price that is lower than the pertinent standard sales price is set in business software or the like, it is possible to adopt a configuration wherein comments are requested from the person responsible, warnings are issued, or the like. In the case where a sales price is set that is lower than the standard sales price, it is also acceptable to have a configuration where the management of the corporation is notified to that effect using the sales price management device 30. Furthermore, it is also possible to have a configuration where the management of the corporation is notified in cases where, for example, a sales price that is at or above the standard sales price has not been set with a customer even when a prescribed period has elapsed.

In the present embodiment, the description concerned the case of a single gross profit rate table, but in cases where multiple products exist, it is preferable to prepare gross profit rate tables for the respective products that take account of the circumstances (sales volumes, gross profit rates and the like) of the respective products.

In the present embodiment, the description concerned required data which is downloaded from business software, but this is only one example. It is also acceptable to have a configuration where, for example, product costs that are personally managed by a user are designated with respect to product costs and the like, or where other logic is appropriately substituted. Furthermore, in the present embodiment, the description concerned computation of a standard sales price based on product cost, but the sales price management device 30 of the present embodiment may also be applied in cases where a standard sales price is computed based not on product cost, but, for example, on parameters relating to the price (determination) of the pertinent product (e.g., external market standards, and the like). Furthermore, in the present embodiment, the description concerned establishment of gross profit rates according to sales volume in the gross profit rate table, but it is also acceptable, for example, to establish gross profit rates according to normative parameters other than sales volume that serve to determine gross profit rates according to business modes. In this case, it is possible to determine a gross profit rate of a product if a normative parameter for determining gross profit rates is inputted.

In the case where sales performance data is, for example, renewed monthly in business software, it is also acceptable to have a configuration where the pertinent sales performance data is downloaded, for example, only with standard sales price computation processing conducted at the beginning of the month, rather than in each case of standard sales price computation processing.

In the present embodiment, the description concerned implementation of the present invention only with the sales price management device 30, but it is also acceptable to implement the present invention, for example, as a sales price management system composed of the sales price management device 30 (i.e., a server) and a terminal (user terminal) that is communicably connected to the pertinent sales price management device 30. In this case, with respect to the aforementioned standard sales price computation processing, one may, for example, input an added-value rank at the terminal, and subsequently transmit it to the sales price management device 30. Moreover, with respect to standard sales price display processing, a product code may be transmitted to the sales price management device 30 after being inputted at the terminal, standard sales price data obtained by the pertinent standard sales price management device 30 may be transmitted to the terminal, and a standard sales price or the like of the product shown by the pertinent standard sales price data (i.e., the above-described standard sales price confirmation screen shown in FIG. 18) may be displayed by the pertinent terminal. The sales price management device of each of the following embodiments may similarly also be implemented as a sales price management system.

### Embodiment 2

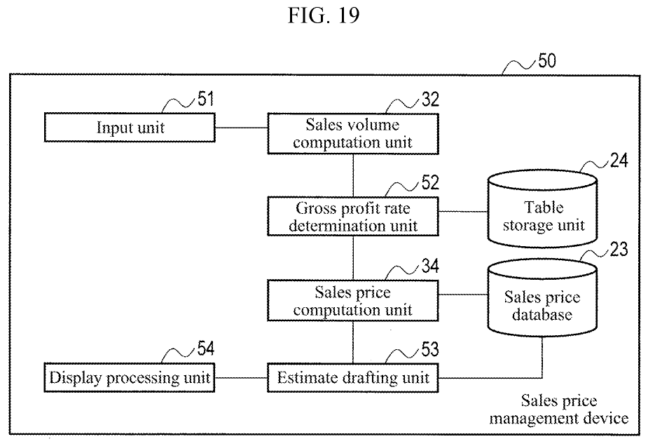

Next, a second embodiment of the present invention is described with reference to FIG. 19. FIG. 19 is a block diagram which shows the main functional configuration of a sales price management device 50 of this embodiment. Components identical to those of the above-described FIG. 2 are assigned identical reference numbers, and detailed description thereof is omitted. The description given here mainly concerns components which differ from those of FIG. 2.

As the hardware configuration of the sales price management device 50 of the present embodiment is identical to that of the sales price management device 30 of the above-described first embodiment, the description accordingly uses FIG. 1.

As shown in FIG. 19, the sales price management device 50 includes an input unit 51, a gross profit rate determination unit 52, an estimate preparation unit 53, and a display processing unit 54. In the present embodiment, these respective units 51-54 are actualized by having the computer 10 shown in FIG. 1 execute the program 21 stored in the external memory 20.

In addition, the sales price management device 50 includes the table storage unit 24. In the present embodiment, the table storage unit 24 is stored, for example, in the external memory 20.

In addition to the gross profit rate table, exception table, and added-value table described in the foregoing first embodiment, the table storage unit 24 also stores a planned sales volume table.

For each planned sales volume (rank) of a product, the planned sales volume table establishes in advance gross profit rates to be added (hereinafter denoted as “additional gross profit rates”) according to the pertinent planned sales volume. Specifically, the planned sales volume table establishes, for each rank, a correspondence between (data showing) the range of planned sales volumes equivalent to the pertinent rank and an additional gross profit rate corresponding to the pertinent rank (range of planned sales volumes). The input unit 51 inputs data (hereinafter denoted as “planned sales volume data”) showing planned sales volumes of the pertinent product to customers who are to be sales recipients of the product (i.e., quantities of the product that the pertinent customer plans to purchase).

The gross profit rate determination unit 52 references the planned sales volume table stored in the table storage unit 22, and specifies an additional gross profit rate that is added according to the planned sales volume of the product shown by the planned sales volume data inputted by the input unit 51.

The gross profit rate determination unit 52 determines the gross profit rate of the pertinent product by adding the specified additional gross profit rate to the gross profit rate corresponding to the sales volume of the product computed by the sales volume computation unit 32.

The estimate preparation unit 53 drafts estimates for the aforementioned customers based on a normative sales price (standard sales price) of the product computed by the sales price computation unit 34. The display processing unit 54 displays the estimates drafted by the estimate preparation unit 53.

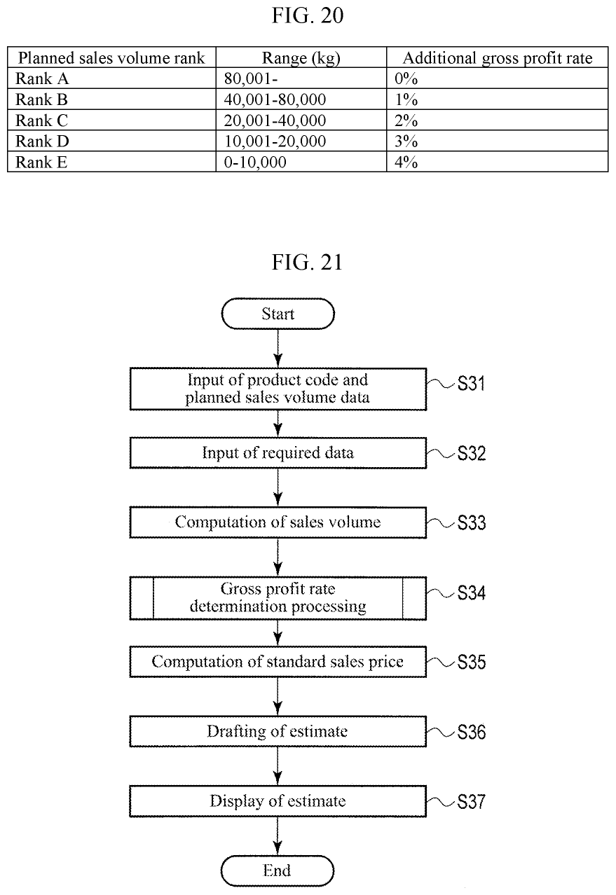

Referring to FIG. 20, a detailed description will now be given of a planned sales volume table stored in the table storage unit 24 shown in FIG. 19. FIG. 20 shows one example of a data structure of a planned sales volume table stored in the table 24 [sic].

As shown in FIG. 20, the planned sales volume table establishes correspondences between planned sales volume ranks, ranges, and gross profit rates. Planned sales volume ranks express planned sales volumes of the product in a ranking format, including, for example, ranks A to E. Ranges indicate ranges (kg) of planned sales volumes of the product equivalent to corresponding planned sales volumes.

Additional gross profit rates indicate gross profit rates to be added according to corresponding (ranges of planned sales volumes equivalent to) planned sales volume ranks.

In the example shown in FIG. 3, the planned sales volume table establishes a correspondence among a planned sales volume rank of “rank A,” a range of “80,001-,” and an additional gross profit rate of “0%.” According to this, it is indicated that the range equivalent to the planned sales volume rank of “rank A” is 80,001 (kg) or more, and that the gross profit rate to be added corresponding to the pertinent planned sales volume rank of “rank A” is 0%.

In addition, the planned sales volume table establishes a correspondence among a planned sales volume rank of “rank B,” a range of “40,001-80,000,” and an additional gross profit rate of “1%.” According to this, it is indicated that the range equivalent to the planned sales volume rank of “rank B” is 40,001 (kg) to 80,000 (kg), and that the gross profit rate to be added corresponding to the pertinent planned sales volume rank of “rank B” is 1%.

Furthermore, the planned sales volume table establishes a correspondence among a planned sales volume rank of “rank C,” a range of “20,001-40,000,” and an additional gross profit rate of “2%.” According to this, it is indicated that the range equivalent to the planned sales volume rank of “rank C” is 20,001 (kg) to 40,000 (kg), and that the gross profit rate to be added corresponding to the pertinent planned sales volume rank of “rank C” is 2%.

In addition, the planned sales volume table establishes a correspondence among a planned sales volume rank of “rank D,” a range of “10,001-20,000” and additional gross profit rate of “3%.” According to this, it is indicated that the range equivalent to the planned sales volume rank of “rank D” is 10,001 (kg) to 20,000 (kg), and that the gross profit rate to be added corresponding to the pertinent planned sales volume rank of “rank D” is 3%.

Similarly, the planned sales volume table establishes a correspondence among a planned sales volume rank of “rank E,” a range of “0-10,000,” and an additional gross profit rate of “4%.” According to this, it is indicated that the range equivalent to the planned sales volume rank of “rank E” is 0 (kg) to 10,000 (kg), and that the gross profit rate to be added corresponding to the pertinent planned sales volume rank of “rank E” is 4%.

Thus, in the planned sales volume table, the gross profit rate to be added (additional gross profit rate) is set so as to decline as planned sales volume increases.

The description given here concerned a single planned sales volume table, but in cases where multiple products exist, one may prepare planned sales volume tables for the respective products that take account of sales volumes and the like of the respective products.

Next, a description is given of the operations of the sales price management device 50 of the present embodiment. With respect to the sales price management device 50 of the present embodiment, in addition to the standard sales price computation processing and standard sales price display processing described in the foregoing first embodiment, processing which drafts estimates for customers (hereinafter denoted as “estimate preparation processing”) is also performed.

Referring to the flowchart of FIG. 21, the processing sequence of estimate preparation processing performed in the sales price management device 50 of the present embodiment is now described.

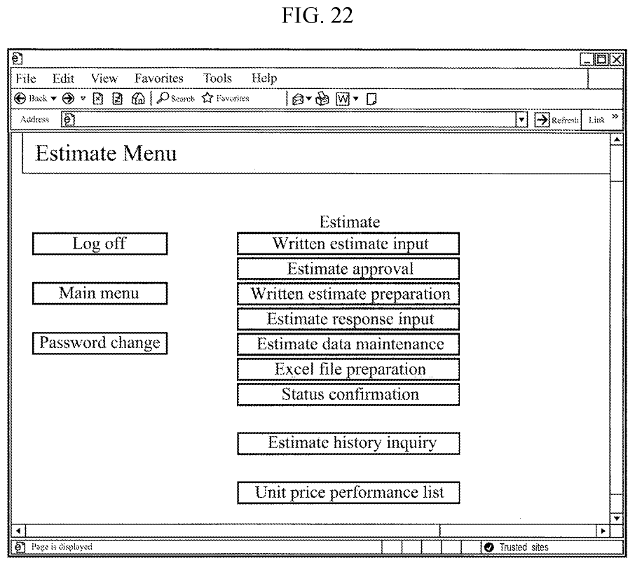

For example, in the case where the “estimate” button is pressed on the above-described main menu screen shown in FIG. 17, an estimate menu screen is displayed as shown in FIG. 22. Estimate preparation processing is performed by pressing (designating), for example, a “written estimate preparation” button on this estimate menu screen.

First, the input unit 51 inputs product codes and planned sales volume data according to the manipulation of the user (step S31). The product codes inputted by the input unit 51 are product codes that serve to identify products that are (planned) to be sold to customers, and are designated, for example, by the user. The planned sales volume data inputted by the input unit 51 shows planned sales volumes of the products to be sold to customers, and is similarly designated by the user.

In addition, the input unit 51 inputs data that is required for estimate preparation processing (step S32). Here, the input unit 51 inputs at least a product master, product cost master, and sales performance data (sales volume data). All of this data may be downloaded from, for example, a business software or the like as mentioned above. As (the data structure of) this data is as described in the foregoing first embodiment, detailed description thereof is omitted. In the description given here, all of this data is downloaded from business software or the like, but in the case where this data is stored in a sales price database 23 as described in the foregoing first embodiment, one may adopt a configuration where it is obtained from the pertinent sales database 23.

Apart from this data, the input unit 51 also inputs added-value ranks of products which are designated by the user. Next, the sales volume computation unit 32 computes a sales volume (e.g., the total sales volume for all customers over the past one year) of a product identified by a pertinent product code (step S33). In this case, the sales volume computation unit 32 computes the total of the sales volumes included in the sales performance data corresponding to the product code inputted by the input unit 51.

The gross profit rate determination unit 52 performs processing (gross profit rate determination processing) that determines the gross profit rate (%) of a product based on planned sales volume data inputted by the input unit 51 and a sales volume of the pertinent product computed by the sales volume computation unit 32 (step S34). At this time, the gross profit rate determination unit 52 performs the gross profit rate determination processing by referring to the gross profit rate table, exception table, and added-value table stored in the table storage unit 24.

The sales price computation unit 34 computes a standard sales price of a product based on the cost of the pertinent product (the cost of a product identified by a product code inputted in step S1) contained in the product cost master inputted by the input unit 51 and the gross profit rate of the pertinent product determined by the gross profit rate determination unit 52 (step S35).

The standard sales price of a product is computed by obtaining X in the calculation formula of “(X−cost of product) I X=gross profit rate of product,” as in the foregoing first embodiment. The standard sales price of this product is a sales price per 1 kg (i.e., a unit price) of the pertinent product as mentioned above.

Next, the estimate preparation unit 53 drafts an estimate for a customer based on a standard sales price of the product computed by the sales price computation unit 34 (step S36). At this time, the estimate preparation unit 53 drafts an estimate including a total amount for the case where, for example, a product (a product identified by a product code inputted in step S1) with a planned sales volume indicated by planned sales volume data inputted in step S1 is sold at a standard sales price of the product computed by the sales price computation unit 34. The estimate preparation unit 53 appropriately utilizes, for example, the data inputted in step S32 to draft the estimate.

The display processing unit 54 displays the estimate drafted by the estimate preparation unit 53 (step S37).

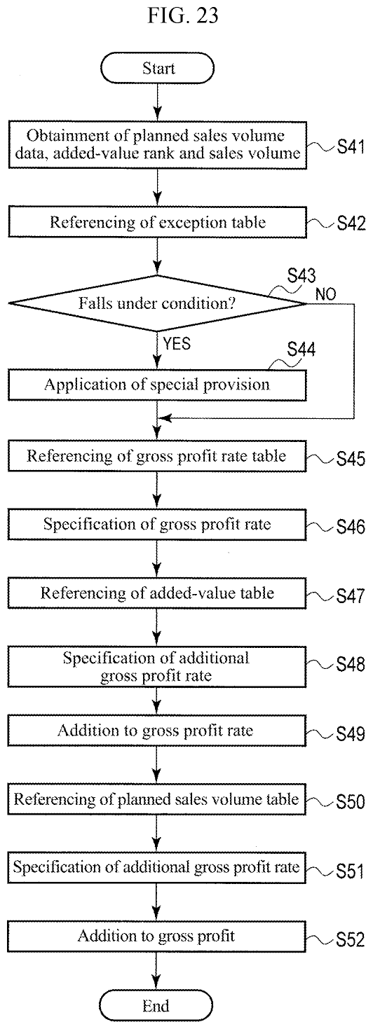

Next, referring to the flowchart shown in FIG. 23, the processing sequence of gross profit rate determination processing performed by the aforementioned gross profit rate determination unit 52 is described.

First, the gross profit rate determination unit 52 obtains the planned sales volume data and added-value rank of a product identified by a product code which were inputted by the input unit 31 [sic], and the sales volume (sold amount) of the pertinent product computed by the sales volume computation unit 32 (step S41). In addition, the gross profit rate determination unit 33 [sic] obtains product data (data relating to the product) contained in the product master inputted by the input unit 51.

Next, the gross profit rate determination unit 52 references the exception table stored in the table storage unit 24 (step S42).

The gross profit rate determination unit 52 determines whether or not the product falls under the conditions retained in the exception table based on the obtained product data (step S43).

In the case where it is determined that the product falls under the conditions (YES of step S43), the special provisions defined in the exception table that correspond to the conditions under which the pertinent product falls are applied (step S44). As the processing of this step S44 is identical to the processing of step S14 shown in the aforementioned FIG. 15, detailed description thereof is omitted.

On the other hand, in the case where it is determined that the product does not fall under the conditions (NO of step S43), the processing of step S44 is not performed.

Next, the gross profit rate determination unit 52 references the gross profit rate table stored in the table storage unit 24 (step S45).

The gross profit rate determination unit 52 specifies a gross profit rate corresponding to a sales volume of the product obtained in step S41 or a processing result of the aforementioned step S44 (step S46). As the processing of this step S46 is identical to the processing of step S16 shown in the aforementioned FIG. 15, detailed description thereof is omitted.

The gross profit rate determination unit 52 references the added-value table stored in the table storage unit 24 (step S47). The gross profit rate determination unit 52 specifies an additional gross profit rate responding to an added-value rank obtained in step S41 (step S48). Specifically, the gross profit rate determination unit 52 specifies an additional gross profit rate retained in the added-value table corresponding to an added-value rank obtained in step S41.

The gross profit rate determination unit 52 adds the additional gross profit rate specified in step S48 to the gross profit rate specified in step S46 (step S49).

Next, the gross profit rate determination unit 52 references the planned sales volume table stored in the table storage unit 24 (step S50).

The gross profit rate determination unit 52 specifies an additional gross profit rate corresponding to a planned sales volume indicated by the planned sales volume data obtained in step S41 (step S51).

Specifically, the gross profit rate determination unit 52 specifies an additional gross profit rate retained in the planned sales volume table corresponding to a planned sales volume rank that corresponds to a range within which the planned sales volume falls according to the obtained planned sales volume data. According to the planned sales volume table shown by the aforementioned FIG. 20, in the case where, for example, the planned sales volume amount indicated by the planned sales volume data obtained in step S41 is 5,000 (kg), 4% is specified as the additional gross profit rate.

The gross profit rate determination unit 52 adds the additional gross profit rate specified in step S51 to the gross profit rate after addition of the additional gross profit rate in step S49.

When the processing of step S52 is performed, the gross profit rate after addition of the additional gross profit rate in the pertinent step S52 is transmitted to the sales price computation unit 34 as the processing result of gross profit rate determination processing (i.e., the gross profit rate of the product).

The description given here concerned determination of the gross profit rate of a product using all of the tables—gross profit rate table, exception table, added-value table, and planned sales volume table—stored in the table storage unit 24, but it is also acceptable to have a configuration where the gross profit rate of a product is determined, for example, using only a gross profit rate table and a planned sales volume table, or a configuration where the gross profit rate of a product is determined using either a gross profit rate table and a planned sales volume table or an exception table and an added-value table.

In the present embodiment as described above, by means of a configuration wherein a planned sales volume table is referenced to specify an additional gross profit rate to be added corresponding to a planned sales volume of a product (a quantity that one plans to sell to a customer) indicated by sales volume data, a gross profit rate of the pertinent product is determined by adding the pertinent specified additional gross profit rate to a gross profit rate corresponding to the sales volume of the product, a standard sales price of the pertinent product is computed based on the cost of the pertinent product and the gross profit rate of the pertinent product, and an estimate is drafted for a customer based on the standard sales price of the pertinent product, it is possible to minutely adjust the gross profit rate taking into consideration a planned sales volume for a customer (i.e., a sales volume that has been committed to a customer), thereby enabling drafting of an estimate based on an appropriate standard sales price corresponding to the pertinent customer.

The sales price management device 50 of the present embodiment may also have a function that displays monetary amounts of prepared estimates and actual monetary amounts to managers and the like of a corporation that utilizes the pertinent sales price management device 50. Actual monetary amounts are inputted in advance to the sales price management device 50 by the salesperson or the like who sold the product to the customer. By this means, in the case where, for example, an actual monetary amount is lower than an estimated monetary amount, a manager can admonish the salesperson to conduct further negotiations so as to correct the pertinent monetary amount, and can inhibit continuation of transactions at a monetary amount that is lower than an estimated amount. Furthermore, in the case where a sales volume pertaining to a customer that results from actual sales of a product does not reach a planned sales volume established at the time of estimate preparation, it is also possible to present the estimate to the pertinent customer, and conduct further negotiations for product purchase or sales price increase.

It is also acceptable to implement the present invention as a sales price management system as described above. In this case, with respect to the aforementioned estimate preparation processing, one may, for example, transmit product codes and added-value ranks to the sales price management device 50 (i.e., the server) after they have been inputted by the terminal, transmit the estimates drafted by the sales price management device 50 to the terminal, and display the pertinent estimates with the pertinent terminal.

### Embodiment 3

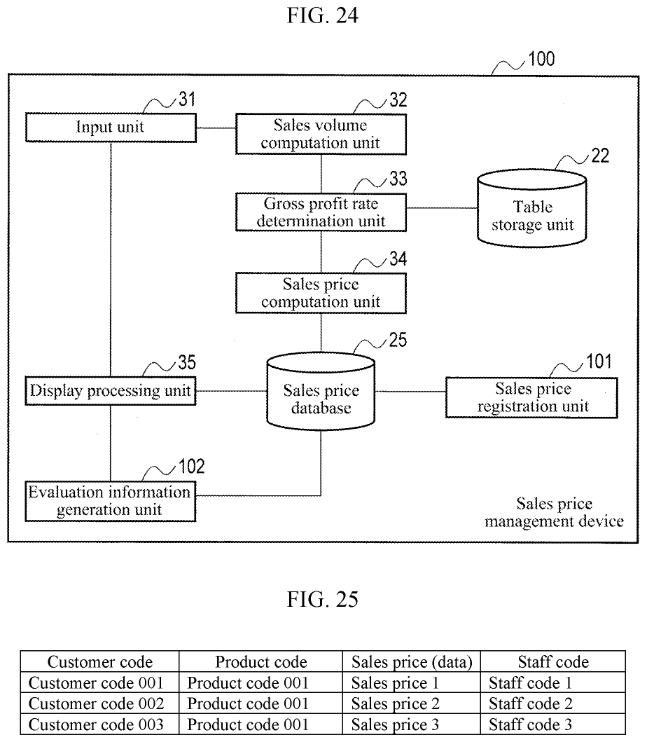

Next, a third embodiment of the present invention is described with reference to FIG. 24. FIG. 24 is a block diagram which shows the main functional configuration of a sales price management device 100 of the present embodiment. Components identical to those of the above-described FIG. 2 are assigned identical reference numbers, and detailed description thereof is omitted. The description given here mainly concerns components which differ from those of FIG. 2.

As the hardware configuration of the sales price management device 100 of the present embodiment is identical to that of the sales price management device 30 of the above-described first embodiment, the description appropriately uses FIG. 1.

In the present embodiment, the point that differs from the above-described first embodiment (and second embodiment) is that the sales price management device 100 is used to evaluate the sales performance of sales staff members (hereinafter simply “staff members”) who sell products to customers who are sales recipients of the pertinent products.

As shown in FIG. 24, the sales price management device 100 includes a sales price registration unit 101 and an evaluation information generation unit 102. In the present embodiment, these respective units 101 and 102 are actualized by having the computer 10 shown in FIG. 1 execute the program 21 stored in the external memory 20.

The sales price management device 100 also includes a sales price database 25. In the present embodiment, the sales price database 25 is stored, for example, in the external memory 20.

In accordance with operations of the pertinent staff member, for example, the sales price registration unit 101 inputs an identifier that serves to identify the pertinent staff member (hereinafter “staff code”), and sales price data that shows the sales prices of products set by the pertinent staff member with respect to customers (i.e., sales prices of products under contract with the pertinent customer). The sales price registration unit 101 registers the inputted sales price data in (the unit price master stored in) the sales price database 25 in association with the staff code. Otherwise, the sales price data inputted by the sales price registration unit 101 overwrites the sales prices (data) that are contained in the unit price master stored in the sales price database 25 explained in the above-described first embodiment.

The evaluation information generation unit 102 inputs the staff code (a staff code that serves to identify a staff member whose sales performance is evaluated) designated by the user via, for example, the input unit 31. Based on the inputted staff code, the evaluation information generation unit 102 generates information that serves to evaluate the sales performance of a staff member identified by the pertinent staff code (hereinafter “evaluation information”). At this time, the evaluation information generation unit 102 references the sales price database 25 to generate the evaluation information. The evaluation information generated by the evaluation information generation unit 102 is displayed via the display processing unit 35.

FIG. 25 shows an example of a data structure of a unit master stored in the sales price database 25 shown in FIG. 24 after registration of sales price data as described above.

As shown in FIG. 25, the unit master stored in the sales price database 25 associatively contains customer codes, product codes, sales prices (data), and staff codes.

As the customer code and product code are as described in FIG. 10 explained above, detailed description thereof is omitted.

The sales price data shows sales prices of products (products identified by assigned product codes) that are set with respect to customers (customers identified by assigned customer codes).

The staff code is an identifier that serves to identify a staff member who has set product sales prices shown by the associated sales price data.

In the example shown in FIG. 25, the unit master associatively contains a customer code “customer code 001,” a product code “product code 001,” a sales price “sales price 1,” and a staff code “staff code 1.” As a result, it is shown that the sales price of the product identified by the product code “product code 001” that is set with respect to the customer identified by the customer code “customer code 001” is sales price 1, and that this sales price 1 was set by a staff member identified by the staff code “staff code 1.”

In addition, the unit master associatively contains a customer code “customer code 002,” a product code “product code 001,” a sales price “sales price 2,” and a staff code “staff code 2.” As a result, it is shown that the sales price of the product identified by the product code “product code 001” that is set with respect to the customer identified by the customer code “customer code 002” is sales price 2, and that this sales price 2 was set by a staff member identified by the staff code “staff code 2.”

In addition, the unit master associatively contains a customer code “customer code 003,” a product code “product code 001,” a sales price “sales price 3,” and a staff code “staff code 3.” As a result, it is shown that the sales price of the product identified by the product code “product code 001” that is set with respect to the customer identified by the customer code “customer code 003” is sales price 3, and that this sales price 3 was set by a staff member identified by the staff code “staff code 3.”

Next, a description is given of operations of the sales price management device 100 of the present embodiment. With respect to the sales price management device 100 of the present embodiment, in addition to the standard sales price computation processing and standard sales price display processing explained in the above-described first embodiment, processing which generates evaluation information that serves to evaluate the sales performance of a staff member (hereinafter “sales performance evaluation processing”) is also performed.

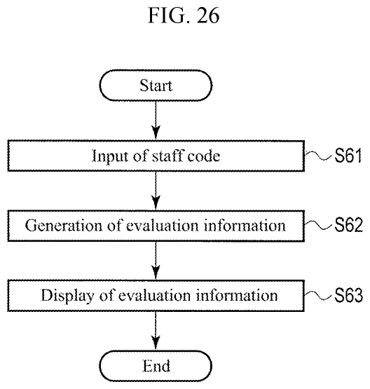

The processing sequence of sales performance evaluation processing performed in the sales price management device 100 of the present embodiment is now described with reference to the flowchart of FIG. 26.

As described in the foregoing FIG. 25, sales price data which shows the sales prices of products set by various sales members with respect to customers is registered in (the unit master stored in) the sales price database 25.

First, the evaluation information generation unit 102 inputs a staff code that serves to identify a staff member whose sales performance is to be evaluated (hereinafter “subject staff member”) (step S61). This staff code is designated by a user, and is inputted via the input unit 31. Here, users who designate a staff member code include, for example, managers and the like of the corporation that utilizes the sales price management device 100.

Next, the evaluation information generation unit 102 acquires all of the customer codes, product codes and sales price data registered in the sales price database 25 in association with the inputted staff code. The evaluation information generation unit 102 also acquires standard sales price data stored in the sales price database 23 [sic] in association with the acquired product codes (i.e., standard sales price data showing normative sales prices of products identified by the pertinent product codes).

The evaluation information generation unit 102 generates evaluation information that serves to evaluate a sales performance of a subject sales member including the acquired customer codes, product codes, sales price data, and standard sales price data (hereinafter “evaluation information of a subject staff member”) (step S62).

The evaluation information generation unit 102 generates, for example, a customer code, product code, sales price data, and standard sales price data in one set as evaluation information. In other words, the evaluation information generation unit 102 generates evaluation information of a subject staff member by sales price set by the pertinent subject staff member (i.e., by sales price data registered by the sales price registration unit 101).

Each piece of evaluation information pertaining to a subject staff member generated by the evaluation information generation unit 102 is displayed to a manager or the like (user) of the corporation that utilizes the sales price management device 100 via, for example, the display processing unit 35 (step S63).

With respect to evaluation information pertaining to a subject staff member (i.e., evaluation information pertaining to a subject staff member generated by the evaluation information generation unit 102) that is displayed to a manager in the aforementioned sales performance evaluation processing, it is sufficient if the information allows the pertinent manager to recognize what sales price is set by the pertinent subject staff member relative to the respective customer and the respective product compared to the normative sales price (standard sales price). That is, it is sufficient if evaluation information of a subject staff member includes at least sales price data that shows the sales price of each product set for each customer by the pertinent subject staff member, and standard sales price data that shows the standard sales price. Other data useful for evaluating the sales performance of the pertinent subject staff member (for example, data such as the customer, the product, the date on which the sales price was set, and the number of articles of the pertinent product that were sold) may also be suitably included.

It is also acceptable to have a configuration wherein, for example, an evaluation rank is generated for display as evaluation information of the subject staff member based on results of comparison of a sales price of a product and a standard sales price of the pertinent product that are included in each piece of evaluation information of the subject staff member (i.e., whether or not the sales price of the pertinent product is at or above the standard sales price of the pertinent product). Specifically, it is acceptable to generate for display an evaluation rank that corresponds to the number (or proportion) of cases where the sales price was set at or above the standard sales price among the various pieces of evaluation information of the subject staff member (i.e., the sales prices set by the pertinent subject staff member).

Furthermore, with respect to evaluation information of a subject staff member, it is also acceptable to consider the sales volume actually sold to the customer by the pertinent subject staff member. Specifically, the total profit obtained by the subject staff member computed from the gross profit of a product sold to a customer by the subject staff member and the sales volume of the pertinent product can be used as evaluation information. The sales volume of a product sold to a customer by the subject staff member can be acquired by referencing the sales price database 25.

In this case, even if, for example, sales prices at or above standard sales prices were set for all products, the evaluation of the subject staff member could be lowered in the case where the sales volumes of the pertinent products were small (i.e., overall profit was small).

In the case where, for example, the sales price of a product is not increased despite a rise in the cost of the pertinent product, the evaluation of the subject staff member who sold the pertinent product would be lowered due to the decline in overall profit. On the other hand, with respect to a subject staff member who does not decrease the sales price of a product even when the cost of the pertinent product falls, the evaluation would be enhanced due to the rise in overall profit.

With respect to evaluation information of a subject staff member, by considering, for example, profit in the case where all products sold by the subject staff member are sold at the standard sales prices as a benchmark, it is possible to easily evaluate how much profit is obtained by the pertinent subject staff member relative to the pertinent benchmark.

Thus, a subject staff member can be more appropriately evaluated by considering not simply the sales prices set by the pertinent subject staff member, but the profits obtained by the pertinent subject staff member (the sales volumes of the products sold by the pertinent subject staff member).

With respect to the present embodiment as described above, a staff code that serves to identify a staff member who sells products, and sales price data that shows product sales prices set by the pertinent staff member with respect to customers are associated and registered in the sales price database 25, sales price data registered in the sales price database 25 in association with a staff code designated by a user (a manager of the like), and standard sales price data that shows the standard sales prices of products for which sales prices are shown by the pertinent sales price data are acquired from the sales price database 25, evaluation information is generated that serves to evaluate the sales performance of a staff member identified by the pertinent staff code including the pertinent acquired sales price data and standard sales price data, and the pertinent evaluation information is displayed. By means of this configuration, managers of a corporation that utilizes the sales price management device 100 can easily comprehend what sales prices are being set by a given staff member compared to standard sales prices of products (i.e., the sales performance of the pertinent staff member), and this can be useful in evaluating the sales performance of the pertinent staff member.

Moreover, in the present embodiment, evaluation ranks based on results of comparison of sales prices of products and the standard sales prices of the pertinent products as described above may be generated for display as evaluation information. By this means, managers can more easily grasp the sales performance of staff members.

Although detailed description is omitted, it is also acceptable to have a configuration wherein conditions (levels) are set in advance in the sales price management device 100, and an evaluation rank is generated according to whether or not sales prices set by a staff member satisfy the pertinent conditions.

The evaluation information of the present embodiment can be used with any algorithm that serves to determine bonuses or the like, or evaluate the sales performance of a staff member.

With respect to the present embodiment, the description was such that only the evaluation information of a staff member identified by a staff code designated by a manager or the like is displayed, but it is also acceptable to have a configuration wherein, for example, evaluation information including staff codes, sales price data, customer codes, and product codes as well as standard sales price data showing standard sales prices of products identified by the pertinent product codes registered in the sales price database are generated according to pertinent sales price data (i.e., according to sales prices set by the staff member), and the pertinent generated evaluation information is sorted for display with parameters such as the staff code, customer code, or product code. By means of this configuration, managers and the like can easily conduct comparative examination of sales performances by staff member, by customer, or by product.

With respect to the present embodiment, the description concerned use of evaluation information for purposes of serving to evaluate the sales performance of a staff member by managers, but the pertinent evaluation information can also be used by a staff member to establish targets when setting sales prices with customers.

With respect to the present embodiment, the description was such that all sales price data showing sales prices of products set by a staff member with respect to customers is registered in the sales price database 25. However, by having a configuration wherein, for example, sales prices that are lower than standard sales prices shown by the standard sales price data stored in the sales price database 25 are not registered in the sales price database 25, managers can easily judge that agreement has not been reached with a customer on sales prices that are at or above the standard sales price if the sales prices include in the evaluation information of a staff member are unregistered. Moreover, for example, by additionally registering data such as the date on which commercial negotiations are started by a staff member with a customer, or the date on which a sales price is registered (i.e., the date of contract with a customer), it is possible to add the length of time that elapses until conclusion of a contract with a customer to the evaluation of the staff member.

With respect to the present embodiment, the description was such that sales price data showing sales prices of products set by a staff member with respect to a customer is registered in the sales price database 25, but it is also acceptable to have a configuration wherein the pertinent sales price data is registered in the aforementioned business software or the like, and is suitably acquired for use from the pertinent business software or the like.

The invention of the present patent application is not limited by the respective foregoing embodiments, and may be implemented with modification of components without departing from its spirit or scope. Moreover, various inventions may be formed by appropriate combination of the multiple components disclosed in each of the foregoing embodiments. For example, one may eliminate some components from the totality of components shown in each embodiment. Furthermore, components from the different embodiments may be suitably combined.

1. A computing system comprising:
persistent storage containing a rate table, an exception table, and an added-value table, wherein the rate table respectively associates a plurality of volumes to a plurality of rates, wherein the exception table respectively associates exception conditions to general modifications of the rates of the rate table, and wherein the added-value table respectively associates added-value conditions to additive modifications of the rates of the rate table;
one or more processors configured to:
receive, by way of a graphical user interface, an input specification of a transaction and related data, wherein the related data includes a nominal volume;
determine, from the rate table, a rate associated with the nominal volume;
determine, based on the related data, that an exception condition in the exception table is satisfied;
based on the exception condition in the exception table being satisfied, determine, from the exception table, a general modification to the rate;
determine, based on the related data, that an added-value condition in the added-value table is satisfied;
based on the added-value condition in the added-value table being satisfied, determine, from the added-value table, an additive modification to the rate;
apply, to the rate, the general modification and the additive modification; and
store, in the persistent storage, the rate as modified.

2. The computing system of claim 1, wherein the one or more processors are further configured to:
cause display, by way of the graphical user interface, the rate as modified.

3. The computing system of claim 1, wherein the persistent storage further contains a cost table associating codes with costs, and wherein the one or more processors are further configured to:
receive, by way of the graphical user interface, a code associated with the transaction;
determine, from the cost table, a base cost associated with the code;
calculate, from the base cost and the rate as modified, a final cost; and
store, in the persistent storage, the final cost.

4. The computing system of claim 3, wherein the one or more processors are further configured to:
cause display, by way of the graphical user interface, the final cost.

5. The computing system of claim 1, wherein the volumes and rates in the rate table have an inversely proportional relationship.

6. The computing system of claim 1, wherein the rates in the rate table are between 20% and 50%.

7. The computing system of claim 1, wherein the general modification to the rate specifies a fixed rate.

8. The computing system of claim 1, wherein the general modification to the rate specifies a cyclical rate.

9. The computing system of claim 1, wherein the additive modification to the rate is non-negative.

10. The computing system of claim 1, wherein the additive modification to the rate is between 0% and 15%.

11. The computing system of claim 1, wherein the additive modification to the rate is based on a scarcity of the transaction.

12. The computing system of claim 1, wherein the nominal volume is related to a party with which the transaction is to be carried out.

13. The computing system of claim 1, wherein the transaction is sale of a product or service.

14. A computer-implemented method comprising:
receiving, by way of a graphical user interface, an input specification of a transaction and related data, wherein the related data includes a nominal volume, wherein persistent storage contains a rate table, an exception table, and an added-value table, wherein the rate table respectively associates a plurality of volumes to a plurality of rates, wherein the exception table respectively associates exception conditions to general modifications of the rates of the rate table, and wherein the added-value table respectively associates added-value conditions to additive modifications of the rates of the rate table;
determining, from the rate table, a rate associated with the nominal volume;
determining, based on the related data, that an exception condition in the exception table is satisfied;
based on the exception condition in the exception table being satisfied, determining, from the exception table, a general modification to the rate;
determining, based on the related data, that an added-value condition in the added-value table is satisfied;
based on the added-value condition in the added-value table being satisfied, determining, from the added-value table, an additive modification to the rate;
applying, to the rate, the general modification and the additive modification; and
storing, in the persistent storage, the rate as modified.

15. The computer-implemented method of claim 14, wherein the persistent storage further contains a cost table associating codes with costs, the computer-implemented method further comprising:
receiving, by way of the graphical user interface, a code associated with the transaction;
determining, from the cost table, a base cost associated with the code;
calculating, from the base cost and the rate as modified, a final cost; and
storing, in the persistent storage, the final cost.

16. The computer-implemented method of claim 15, further comprising:
causing display, by way of the graphical user interface, the final cost.

17. The computer-implemented method of claim 14, wherein the volumes and rates in the rate table have an inversely proportional relationship.

18. The computer-implemented method of claim 14, wherein the general modification to the rate specifies a cyclical rate.

19. The computer-implemented method of claim 14, wherein the additive modification to the rate is based on a scarcity of the transaction.

20. A non-transitory computer-readable medium storing program instructions that, when executed by one or more processors, cause a computing device to perform operations comprising:
receiving, by way of a graphical user interface, an input specification of a transaction and related data, wherein the related data includes a nominal volume, wherein persistent storage contains a rate table, an exception table, and an added-value table, wherein the rate table respectively associates a plurality of volumes to a plurality of rates, wherein the exception table respectively associates exception conditions to general modifications of the rates of the rate table, and wherein the added-value table respectively associates added-value conditions to additive modifications of the rates of the rate table;
determining, from the rate table, a rate associated with the nominal volume;
determining, based on the related data, that an exception condition in the exception table is satisfied;
based on the exception condition in the exception table being satisfied, determining, from the exception table, a general modification to the rate;
determining, based on the related data, that an added-value condition in the added-value table is satisfied;
based on the added-value condition in the added-value table being satisfied, determining, from the added-value table, an additive modification to the rate;
applying, to the rate, the general modification and the additive modification; and
storing, in the persistent storage, the rate as modified.
